(19) United States
(12) Patent Application Publication
(10) Pub. No.: US 2015/0246570 A1
(43) Pub. Date: Sep. 3, 2015

(54) MAILING DEVICE

(71) Applicant: FORMOLOGY LTD, Stourton, Near Stourbridge West Midlands (GB)

(72) Inventor: Edward Black, West Midlands (GB)

(21) Appl. No.: 13/261,853

(22) PCT Filed: Jul. 11, 2012
(86) PCT No.: PCT/GB2012/051640

§ 371 Date: May 14, 2015

(30) Foreign Application Priority Data
Jul. 15, 2011 (GB) 1112208.2
Apr. 12, 2012 (GB) 1206419.2

(51) Int. Cl. B42D 15/08; B42D 5/02

(52) U.S. Cl. CPC B42D 15/085; B42D 5/025; B42P 2261/00

(57) ABSTRACT

A mailing device (10) comprises a blank (12) of foldable material defining at least two panels (14, 16) separated by one or more fold lines (18). At least two of the panels (14, 16) have removable edge regions (24, 26, 30) and an inner surface of the removable edge regions of a first of the panels (14) is coated with adhesive to enable the edge regions to be bonded to corresponding removable edge regions of another panel when the blank is folded. A sheet of material (36) is affixed to an inner surface of one of the panels (14) so as to cover an inner region of the panel within the removable edge regions. The sheet (36) may be printed on with a security hatching. Releasable tape (34) may be applied over the adhesive and the sheet (36) may be made of the same material as the release tapes. Various other mailing devices are also disclosed.

### TECHNICAL FIELD OF THE INVENTION

The present invention relates to a mailing device and to methods of manufacturing a mailing device.

### BACKGROUND TO THE INVENTION

It is known to provide a mailing device comprising a blank of foldable material which can be can be printed on and which is subsequently folded and sealed about its edges to form a closed pouch suitable for mailing. Typically, sealed edge regions of the blank are separable from the remainder of the blank along lines of weakness. To open the mailing device, the user tears along the lines of weakness to remove the edge regions so that the mailer can be unfolded. A wide range of mailing devices are provided in this general form, including business mailers and postcards.

Business mailers in particular are often used to convey confidential information. To ensure that the contents of a mailer cannot be read without opening the mailer, say by holding the closed mailer up to the light, it is common practice to print a security pattern or hatching on the outside of the mailer. Whilst this is effective at preventing the contents of the mailer being read, it means that the majority of the exterior of the mailer is not available to be printed on to convey other information, such as the sender's details or trademarks for example. Furthermore, the presence of a security hatching on the exterior of the mailer is often not attractive to the recipient.

It would be desirable, therefore, to provide a mailer in which more of the surface area of the blank is available to be selectively printed on or which can be left blank without compromising the security of the mailer.

Mailing device blanks typically comprise two or more panels separated by fold lines. In order to seal the mailer, an adhesive is typically applied to an inner surface of the removable edge portions of one of the panels so that they can be bonded to corresponding removable edge portions on another of the panels once the mailer has been folded. A variety of adhesives have been used on mailers including pressure sensitive adhesives and contact adhesives. In some arrangements one or more tapes of releasable liner material is/are placed over the adhesive zones to protect the adhesive and to prevent the mailer sticking to other items, particularly other mailers, before it is folded and sealed. This is particularly beneficial where the mailer is to be printed on using a laser or other printer that generates significant heat which can result in the adhesive becoming very tacky and increasing the risk of the mailer jamming if the adhesive is not covered.

In some known manufacturing methods, the one or more tapes of releasable liner material are produced by placing a sheet of liner material over the inner face of the panel so that it covers substantially the whole of the panel, including the adhesive zones on the removable edge regions. The sheet is then die cut along a line, usually just inboard of the lines of weakness, and the central portion of the sheet inside the die cut is removed and discarded. The outer edge portion or portions of the sheet of liner material are releasably held in position by the adhesive and form the release tape or tapes. This method is often used where the panel has three removable edge portions arranged in a U or horseshoe shape extending along either side and one end of the panel. The sheet is die cut along the three sides just inboard of the lines of weakness to form a single U or horseshoe shape release tape when the inner portion is removed.

Whilst this method of manufacture is relative efficient to carry out, it does generate considerable waste as a large proportion of the liner material is simply thrown away. It is also desirable, therefore to provide a mailing device and method of manufacture which is lest wasteful than the known methods.

Further, it would be advantageous to decrease production costs and time by reducing the amount of adhesive needed to securely close the mailer. By requiring less adhesive than conventional mailers, material costs would be reduced and the time needed for applying the adhesive would also be reduced. This would additionally lead to a reduction in the required amount of liner material. It is therefore desirable to provide a mailer which reduces the amount of materials needed.

Whilst mailers provide a very efficient means for senders to communicate with a large number of end users, they are not always popular with recipients. Opening mailers typically requires the recipient to tear off at least two, often three, removable edge regions, sometimes in a particular order. This can be cumbersome and time consuming particularly for people with limited hand strength and/or coordination. It would be desirable, therefore, to provide a mailer that is easier to open than existing mailers.

Mailers are often used to send out marketing and other business and the like on a large scale. However, some recipients dislike mailers and prefer to receive post in more conventional envelopes. It is desirable, therefore, to provide a mailer that retains all the advantages of a mailer for the sender but which more closely resembles a conventional envelope.

### SUMMARY OF THE INVENTION

According to a first aspect of the invention, there is provided a mailing device comprising a blank of foldable material defining at least two panels separated by one or more fold lines, at least two of the panels having removable edge regions defined by means of lines of weakness in the blank, an inner surface of the removable edge regions of a first of the panels having adhesive to enable the edge regions of said first panel to be bonded to corresponding removable edge regions of another panel when the blank is folded, wherein a sheet of material is affixed to an inner surface of one of the panels so as to cover at least an inner region of the panel.

The sheet may be printed on. The sheet may be printed on with a security hatching or other security pattern.

The sheet of material may be affixed to the first panel, the adhesive on the removable edge regions of the first panel being covered by one or more release tapes made of the same material as the sheet.

The one or more tapes of liner and the sheet may be formed from a single piece of die cut material.

The sheet may extend beyond the lines of weakness defining at least two removable edge regions of the first panel so that peripheral portions of the sheet are affixed to the removable edge regions by means of the adhesive thereon.

The first panel may have three removable edge regions, two of the removable edge regions being provided along opposite sides of the first panel and a third removable edge region extending along an end of the first panel interconnecting the sides, the adhesive on all three of the edge regions being covered by a single, continuous, generally U shaped tape of liner material.

The blank may define two panels foldably connected by a first fold line, each of the panels having three removable edge regions, two of the removable edge regions being provided along opposite sides of each respective panel and a third removable edge region extending along an end of the respective panel opposite from the first fold line.

The blank may alternatively define a first, second and third panel, connected by way of first and second fold lines respectively, the third panel being connected to an end of the second panel opposite the end connected to the first panel wherein each of the panels comprise removable edge regions extending longitudinally along opposing sides of the first, second and third panels to form removable side edge regions, wherein first and second transverse lines of weakness extend respectively across the first panel and the second panel parallel to and equi-spaced from the first fold line to form removable end edge regions, and wherein the removable edge regions of said second panel are provided with a plurality of apertures, the arrangement being such that the first and third panels overlay the second panel on opposite sides thereof, the third panel being bonded to the first panel by way of said adhesive exposed through said apertures, when the blank is folded.

The first panel may be provided with adhesive on a free end edge region provided opposite the end of the first panel connected to the second panel. Said adhesive enables the first panel to be securely attached to the second panel along all edges. This reduces the risk of the mailing device being jammed or caught in automated sorting machinery, thereby reducing the risk of damage to the mailing device.

At least one of the apertures may be formed with a number of security cuts, said security cuts being angularly spaced around the border of said at least one aperture. Said security cuts may extend radically from the edge of said aperture(s). The security cuts increase the chance of tearing if a person attempts to open the mailing device by breaking the adhesive bond. This increases the security of the mailing device.

The blank may comprise a transverse line of weakness extends substantially parallel to the free end of the third panel, said line of weakness extending between opposing side edges of the third panel or between said side edge regions of the third panel.

In accordance with a second aspect of the invention, there is provided a method of manufacturing a mailing device in accordance with the first aspect, the method comprising: applying adhesive to the removable edge regions of the first panel portion, positioning a single planer piece of liner material over inner surface of the first panel covering substantially the whole of the first panel including at least those parts of the removable edge portions to which adhesive has been applied, and kiss cutting the piece of material to define the inner sheet and one or more removable tapes of liner material covering the adhesive on the removable edge regions of the first panel.

The method may comprise kiss cutting liner material at positions just outside the lines of weakness within the zones of adhesive applied to the removable edge regions so that peripheral edge portions of the sheet overlay part of the adhesive.

In accordance with a third aspect of the invention, there is provided a mailing device comprising a blank of foldable material defining a first panel, a second panel foldably connected to a first end of the first panel by means of a first fold line, and a closure flap foldably connected to a second end of the first panel opposite the first end by means of a second fold line, wherein first and second transverse lines of weakness extend respectively across the first panel and the closure flap parallel to and equi-spaced from the second fold line, at least part of an outer end region of the cover flap on the opposite side of the second line of weakness from the second fold line having an adhesive on its inner surface, the arrangement being such that the outer end region of the cover flap overlays and can be bonded to an outer face of the second panel in when the blank is folded.

The second panel may be dimensioned so that when folded about the first line, an end of the second panel opposite from the first fold line is positioned proximal to but on the opposite side of the first transverse line of weakness from the second fold line.

Longitudinal lines of weakness may extend along either side of the blank to define removable side edge regions of the first and second panels and the closure flap. In which case, the first and second transverse lines of weakness may extend across the first panel and the cover flap respectively between the longitudinal lines of weakness. Adhesive may be applied to inner surfaces of the removable side edge regions of the first panel and the cover flap. The adhesive on the removable side edge regions of the first panel and the cover flap and the outer edge region of the cover flap may be covered by one or more releasable tapes of liner material.

A sheet of material may be affixed to the blank so as to substantially cover the inner surface of at least an inner region of the first panel within the longitudinal and first transverse lines of weakness. The sheet of material covering the inner region of the first panel may be made from the same material as one or more releasable tapes of liner material covering the adhesive on the removable edge regions of first panel and cover flap. The one or more tapes of liner material and the sheet may be formed from a single piece of die cut material. The sheet is printed on, say with a security hatching or other security pattern.

In accordance with a fourth aspect of the invention, there is provided a mailing device comprising a blank of foldable material defining at least two panels separated by fold lines, at least one of the at least two panels having removable edge regions defined by means of lines of weakness in the blank, a first of the panels having edge regions that contact corresponding removable edge regions of a further one of the panels when the mailer is folded, an inner surface of the edge regions of the one of the first and the further panels having an adhesive for bonding the corresponding removable edge regions together when the blank is folded, a tear strip being affixed to the edge regions of the first panel, the tear strip having a tab portion at one end, the blank having an opening in the further panel which overlays the tab portion when the blank is folded to allow access to the tab portion.

The adhesive may be applied to the edge regions of the first of the panels and a tape of releasable liner material may cover adhesive on the edge regions of the first panel outside the tear strip. The tape of releasable liner material and the tear strip may be made of the same material. The tape of releasable liner material and the tear strip may be formed from a single piece of die cut material.

The tear strip may be positioned so as to align with the line of weakness in the blank defining the at least one removable edge region of the other panel when the mailing device is folded. An inner edge of the tear strip may be positioned to align with the line of weakness in the blank defining the at least one removable edge region of the other panel when the mailing device is folded.

The other panel may have removable edge regions defined along both sides and along one end, and the tear strip may be substantially U or horseshoe shaped to align with the lines of weakness defining the three removable edge regions in the other panel when the blank is folded.

The tear strip/liner material may have a greater tear resistance than the material of the blank.

The tape of releasable liner material may have a width in the range of 4 mm to 6 mm and the inner tear strip portion may have a width of 1 mm to 3 mm.

In one embodiment, the adhesive is applied in strips along the edge regions of the first panel, the outer portion of the tape of releasable liner material overlaying an outer portion of the strips and the tear strip portion overlying an inner portion of the strips.

The first panel may have edge regions defined along both sides and along one end opposite the first fold line, adhesive being applied to an inner surface of the three edge regions of the first panel, the tape of releasable liner material and the tear strip each comprising a single continuous length of releasable liner material having a generally U shape and extending about all three of the edge regions of the first panel.

The edge regions of the first panel may be removable edge regions defined by lines of weakness in the blank.

In accordance with a fifth aspect of the invention, there is provided a method of manufacturing a mailing device according to the fourth aspect of the invention, the method comprising: applying adhesive to the edge regions of the first panel portion, positioning a single planer piece of releasable liner material over inner surface of the first panel covering substantially the whole of the first panel including at least those parts of the edge portions to which adhesive has been applied, kiss cutting the liner material to define inner and outer edges of the tear strip.

The method may further comprise removing the portion of liner material inside the tear strip.

In accordance with a sixth aspect of the invention there is provided a mailing device comprising a blank of foldable material defining a first and second panel connected by way of a first fold line, and defining a third panel connected to the second panel by way of a second fold line, the third panel being connected to an end of the second panel opposite the end connected to the first panel, the panels having removable side edge regions defined by means of lines of weakness formed longitudinally along either side of the panels of the blank, and an inner surface of the removable edge regions of the first panel having adhesive to enable the edge regions of said first panel to be bonded to corresponding removable edge regions of another panel when the blank is folded, wherein first and second transverse lines of weakness extend respectively across the first panel and the second panel parallel to and equi-spaced from the first fold line to form removable end edge regions, and wherein the removable edge portions of said second panel are provided with a plurality of apertures, the arrangement being such that the first and third panels overlay the second panel on opposite sides thereof, the third panel being bonded to the first panel by way of said adhesive exposed through said apertures, when the blank is folded.

A transverse line of weakness may be formed on the third panel, said line of weakness extending between the removable side edge regions across the end of the third panel opposite the end connected to the second panel.

The apertures may have any suitable size or shape. The apertures may cover a substantial portion of the removable edge regions of the second panel, in order to ensure that sufficient adhesive is exposed for bonding the third panel securely to the first panel.

### DETAILED DESCRIPTION OF THE INVENTION

In order that the invention may be more clearly understood embodiments thereof will now be described, by way of example only, with reference to the accompanying drawings, of which:

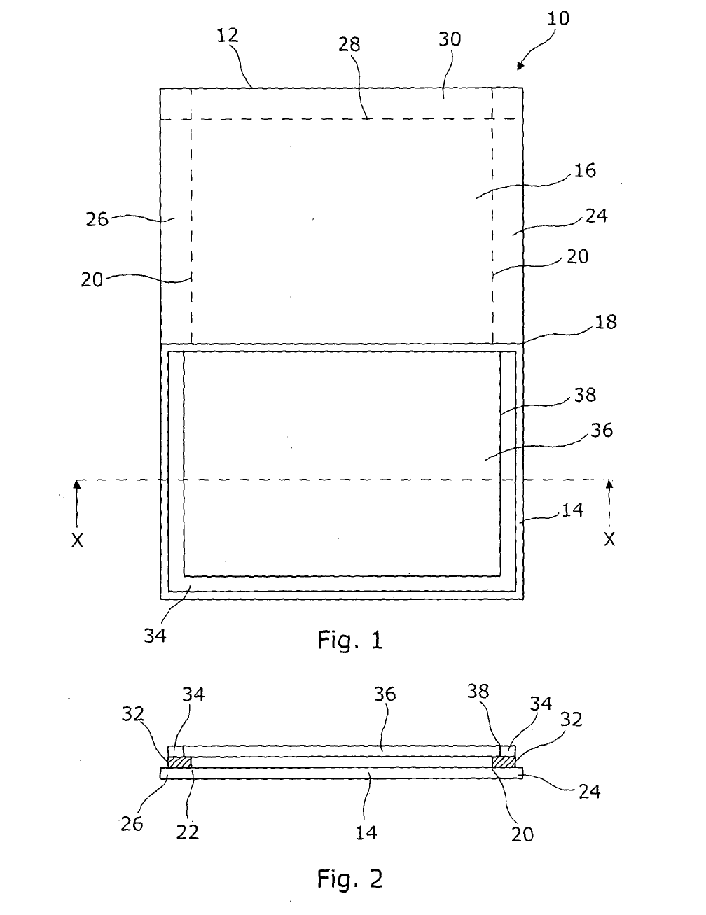

FIG. 1 is a plan view of a first embodiment of a mailing device in accordance with the invention, showing the mailing device prior to folding;

FIG. 2 is a cross sectional view through the mailing device of FIG. 1 taken on line X-X;

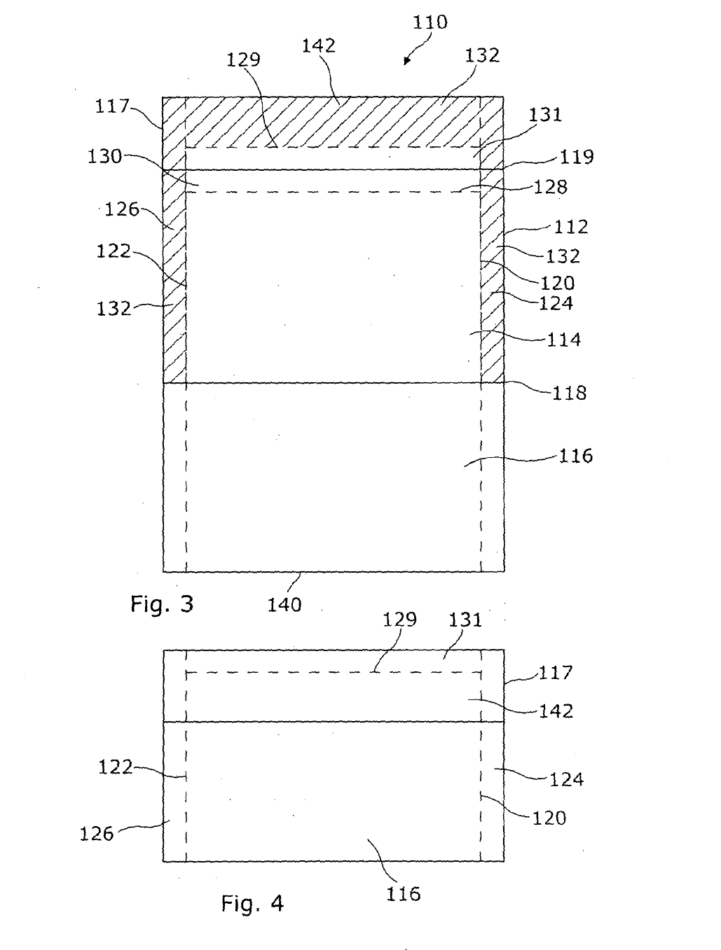

FIG. 3 is a plan view of a second embodiment of a mailing device in accordance with the invention, showing the mailing device prior to folding;

FIG. 4 is a plan view from the rear of the mailing device of FIG. 2, showing the device after folding and sealing;

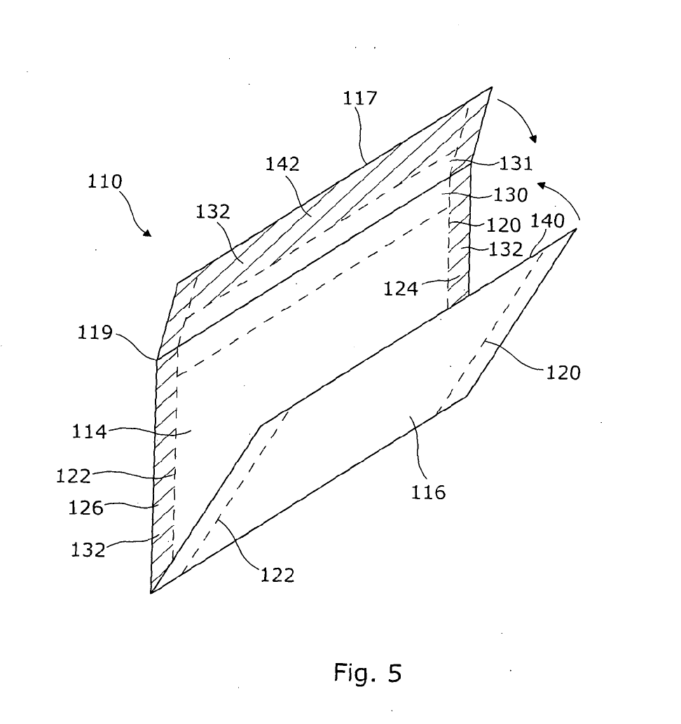

FIG. 5 is a perspective view of the mailing device of FIGS. 4 and 5, showing the device as it is being folded;

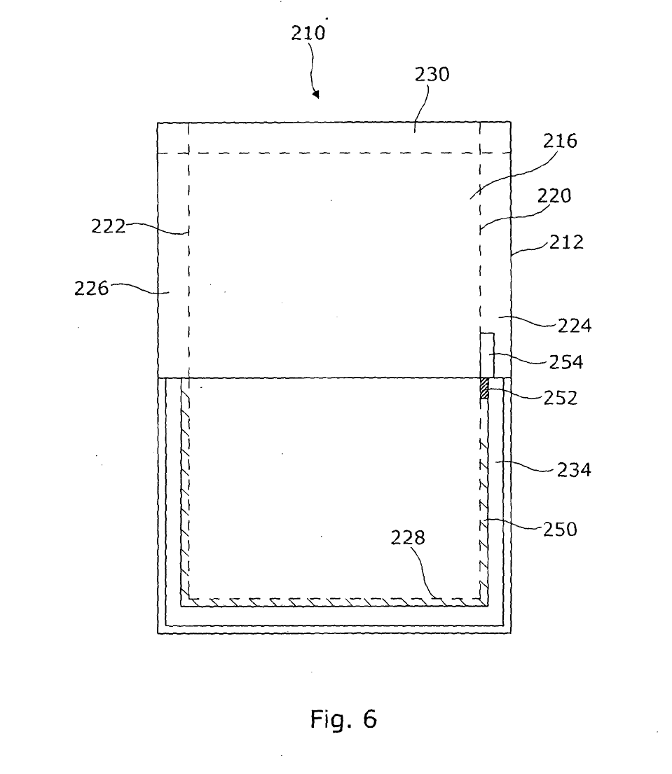

FIG. 6 is a plan view of a third embodiment of a mailing device in accordance with the invention, showing the mailing device prior to folding;

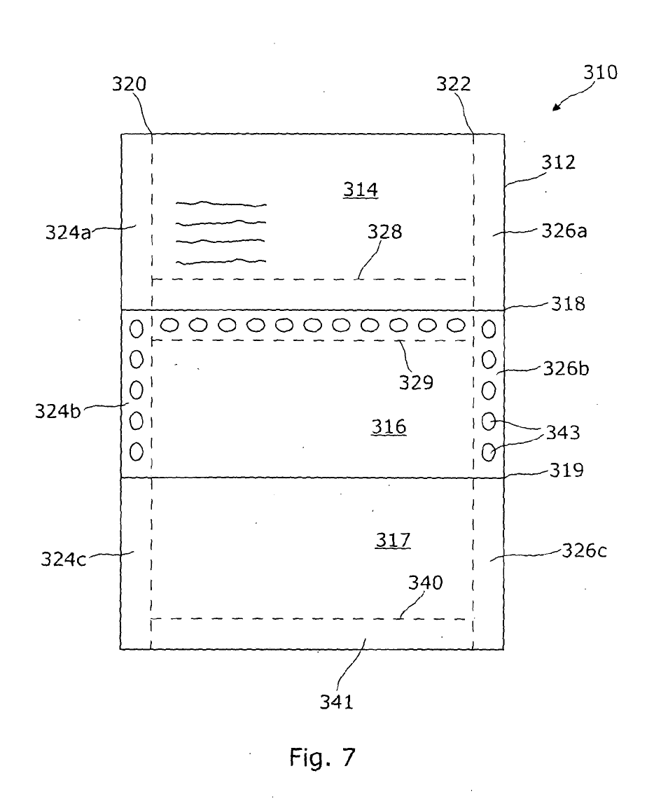

FIG. 7 is a plan view from the front of a fourth embodiment of a mailing device in accordance with the invention, showing the mailing device prior to folding;

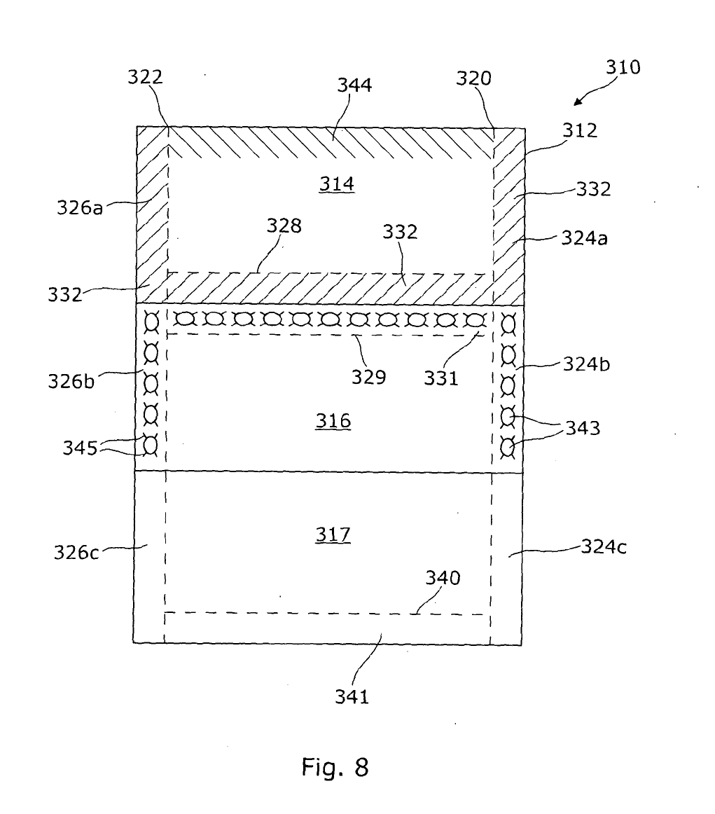

FIG. 8 is a plan view from the rear of the mailing device of FIG. 7 showing the mailing device prior to folding; and

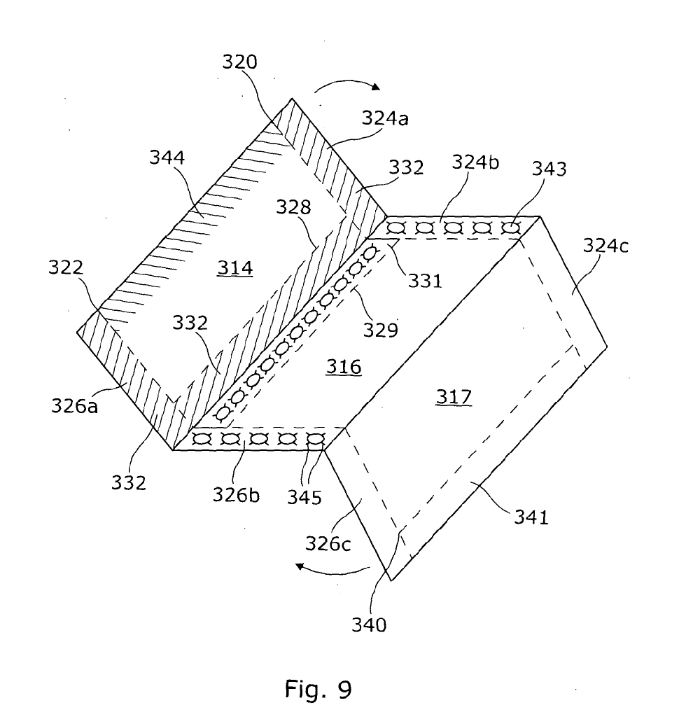

FIG. 9 is a perspective view of the mailing device of FIGS. 7 and 8, showing the device as it is being folded.

The same reference numbers but increased by 100 in each case will be used to identify the same features or features that perform the same function in the following description of the various embodiments of the invention.

In the following, the term “inner surface” refers to a surface which faces another surface when the mailer is in a folded state. Similarly, the term “outer surface” refers to a surface which does not face another surface when the mailer in in a folded state e.g. the surface faces the exterior of the folded mailer.

FIGS. 1 and 2 illustrate a mailing device 10 in accordance with a first embodiment of the invention. The mailing device 10 is in the form of mailer, sometimes referred to as a business or stationery form, comprising a blank 12 of foldable material, such as a paper sheet. The blank is 12 generally rectangular in shape and is divided into a first panel 14 and a second panel 16 by means of a central fold line 18. The two panels are substantially identical in size and shape so that when the blank is folded about the fold line 18, the two panels 14, 16 overlay one another in a manner well known in the art.

Longitudinal lines of weakness 20, 22 extend along either side of the blank 12 to define removable side edge regions 24, 26 on both panels. Transverse lines of weakness 28 extend across the end of each panel 14, 16 remote from the fold line 18 between the longitudinal lines of weakness 20, 22 to define removable end edge regions 30 of the panels. In an alternative arrangement, the transverse lines of weakness 28 can extend across the full width of the blank. In this case, the longitudinal lines of weakness 20, 22 can extend the full lengths of the blank or only between the transverse lines of weakness. The lines of weakness 20, 22, 28 may comprise lines of perforations or score lines. The lines of weakness 20, 22, 28 and the removable edge regions 24, 26, 30 are only shown in FIG. 1 for the second panel 16 but it should be appreciated that panels 14, 16 are substantially mirror images of each other and that the first panel 14 has a similar pattern of lines of weakness and removable edge regions as the second panel 16.

In order to seal the mailing device when the blank 12 is folded, an adhesive 32 is applied to the inner surfaces of the removable edge regions 24, 26, 30 of the first panel. Any suitable adhesive can be used such as a pressure adhesive but in the present embodiment the adhesive is a contact adhesive which will bond on contact with the corresponding removable edge regions 24, 26, 30 of the second panel when the blank is folded about the fold line 18 and the two panels 14, 16 brought into contact. The adhesive 32 is typically applied in strips along each of the removable edge regions.

A generally U or horseshoe shaped tape 34 of releasable liner material covers an outer part of the adhesive on the removable edge regions 24, 26, 30 of the first panel 14. The liner material is typically coated on the side facing the adhesive so that it lightly adheres to but is readily separable from the adhesive. The liner material can be any suitable material known in the art such as a silicon treated paper. Within the tape 34 is located an inner sheet of material 36 which substantially covers an inner region of the first panel within the lines of weakness. The inner sheet is dimensioned so as to extend across the lines of weakness 20, 22, 28 on either side and at the end remote from the fold line so that the peripheral edge of sheet overlays and is adhered to an inner portion of the adhesive in the removable edge regions 24, 26, 30.

The inner sheet of material 36 can be made of any suitable material but is advantageously made of the same liner material as the tape 34. In a particularly advantageous arrangement, the tape 34 and the inner sheet 36 are formed from a single piece of the liner material which is die cut to form the outer tape 34 and the inner sheet. In one method of manufacture, a single planer piece of the liner is positioned over the first panel 14 so as to cover substantially the whole of the panel including the strips of adhesive 32. The material is then kiss cut along the line 38 so as to form the outer tape 24 and the inner sheet 36. Kiss cutting is a process known in the art by which the liner material is cut through without cutting the underlying blank 12. As can be seen from FIG. 2, the material is kiss cut at a position just outboard of the lines of weakness 20, 22, 28 within the strips of adhesive 32 so that the outer peripheral edge of the sheet on three sides is held in position by the adhesive in the removable edge regions whilst the tape 34 covers the remainder of the adhesive. The arrangement is configured so that when the tape 34 is removed, sufficient adhesive is exposed to allow the mailing device to seal satisfactorily. In one embodiment, the adhesive is applied in strips of about 7 mm in width. The release tape 34 is 4 mm in width and the outer periphery of the inner sheet 36 covers the inner 3 mm of the adhesive strips. It will be appreciated though that these dimensions are only exemplary and can be varied as desired.

When the mailer is to be sealed, the tape 34 is peeled away from the adhesive 32 leaving the inner sheet 36 in place. The blank 12 is folded and the panels 14, 16 brought into contact so that the adhesive on the removable edge regions of the first panel exposed by removing the tape bonds with the corresponding removable edge regions of the second panel 16. To open the mailing device 10, the edge regions 24, 26, 30 are removed by tearing along the lines of weakness in the usual manner. The inner sheet is typically made from a paper material that will tear easily when the mailing device 10 is opened and so does not prevent removal of the edge regions 24, 26, 30. However, lines of weakness could be formed in the sheet to align with the lines of weakness in the blank if desired.

The inner sheet 36 can be used in a number of ways. It could be used to provide printed vouchers, tokens or the like or simply as a printed insert for the mailing device. Because the inner sheet 36 is made from a releasable line material, it can be readily removed by peeling it away from the adhesive 32 without being damaged. Alternatively, the inner sheet 36 could be printed with a security hatching pattern to prevent the contents of the mailer being read without opening the mailer. With a security hatching on the inner sheet 36, it is not be necessary to apply a security pattern to the exterior of the blank so that this can be left predominantly blank to give the appearance of a conventional envelope or it could be selectively printed on to provide alternative information or designs as desired by the sender. This significantly increases the available space on the mailer that can be selective printed on. The inner surface of the first panel 14 can still be printed on by pre-printing before the adhesive and liner sheet are applied.

By forming the inner sheet 36 from the liner material, use is made of the inner region of the liner material that is discarded in conventional methods of forming the release tape and so there are little if any additional costs of manufacture and a considerable reduction in waste materials.

It will be appreciated that use of an inner sheet 36 in the manner described and the method of manufacture is not limited to mailers 10 of the type shown in FIGS. 1 and 2 but can be adapted for use in variety of different mailers and mailing devices comprising a foldable blank having two or more foldable panels. Furthermore, in an alternative arrangement the inner sheet may be held in position using adhesive applied to the inner region of the first panel 14 inside the lines of weakness that define the removable edger regions. The adhesive may be applied in discreet locations inside the lines of weakness or the strips of adhesive applied to the removable edge regions could be extended inwardly across the lines of weakness to cover peripheral portions of the inner region. In this case, the piece of liner material could be kiss cut in line with the lines of weakness or just inboard of the lines of weakness.

FIGS. 3 to 5 illustrate a second embodiment of a mailing device 100 in accordance with the invention.

The mailing device 110 is also in the form of mailer, sometimes referred to as a business or stationery form, comprising a blank 112 of foldable material, such as a paper sheet. The blank 112 is generally rectangular in shape and is divided into a first panel 114, a second panel 116, and a closure flap 117 by means of transverse fold lines 118, 119.

Longitudinal lines of weakness 120, 122 extend along either side of the blank 12 to define removable side edge regions 124, 126 in both panels and in the closure flap 117. A first transverse line of weakness 128 extends across the first panel 114 between the longitudinal lines of weakness 120, 122 spaced below the second fold line 119 to define a removable end region 130 of the first panel 114. A second transverse line of weakness 129 extends across the closure flap 117 between the longitudinal lines of weakness 120, 122 to define a removable region 131 of the closure flap. The first and second transverse lines of weakness 128, 129 are equi-spaced about the second fold line 119.

The blank is dimensioned so that the second panel 116 can be fold about the first fold line 118 to overlay the first panel 114 with the end 140 of the second panel opposite the first fold line being positioned just below or inside the first transverse line of weakness 128 and the closure flap 117 folded about the second fold line 119 so that at least part of an outer end region 142 of the closure flap outboard of the second transverse lines of weakness 129 overlays the part of the second panel 116 in a region close to the end 140 opposite the first fold line 118 as illustrated in FIG. 5.

In order to seal the mailing device when the blank 112 is folded, an adhesive 132 is applied to the inner surfaces of the removable side edge regions 124, 126, of the first panel 114 and the closure flap and to at least part of the outer end region 142 of the closure flap. Any suitable adhesive can be used such as a pressure adhesive but in the present embodiment the adhesive is a contact adhesive of the type described in relation to the first embodiment. A generally U or horseshoe shaped tape (not shown) of releasable liner material will be provided to the adhesive in a manner known in the art and/or as described in relation to the first embodiment.

To close the mailer, the release liner is removed and the second panel 116 folded about the first fold line 118 over the first panel 114 so that the side edge regions of the two panels are bonded together. The closure flap 117 is folded down about the second fold line 119 so that the outer end region 142 of the closure flap is brought into contact with and bonded to the outer surface of the second panel 116 adjacent the end 140. The removable side edge regions of the 124, 126 of the closure flap 117 bond partly to themselves and partly with the outer surface of the second panel. When the mailer 100 is folded, the first and second transverse lines of weakness 128, 129 align with one another.

To open the mailer, the recipient tears along the longitudinal lines of weakness to remove the side edge regions 124, 126. The recipient then tears along the top of the mailer along the first and second transverse lines of weakness 128, 129 to remove the end region 130 of the first panel and the removable region 131 of the closure flap 117. This leaves the outer end region 142 of the closure flap 117 bonded to the rear or outer surface of the second panel 116.

The mailing device 110 in accordance with the second embodiment has the advantage that it more closely physically resembles the physical appearance of a conventional envelope whilst still retaining the advantages of a mailer. In an alternative arrangement, the first and second transverse lines of weakness 128, 129 can be made to extend fully across the blank so that the recipient opens the mailer be tearing across the top portion first before removing the side regions 124, 126.

The mailer 110 in accordance with the second embodiment can incorporate an inner sheet in a manner similar to the first embodiment. The inner sheet and the release tape can be formed from a single piece of liner material which is positioned so as to cover both the first panel 114 and the closure flap 117 and bonded to the zones of adhesive 132. The material is then kiss cut to define the tape and the inner sheet in the manner described above. In the present embodiment, the inner sheet may only cover the first panel in the region between the first fold line 118 and the first transverse line of weakness 128. In this case, the region of liner material that initially covers the area between the first and second lines of weakness 128, 129 is removed and discarded after the liner material is kiss cut. The inner sheet in this case will only be held in position along its side edges where it extends across the longitudinal lines of weakness 120, 122 to share the adhesive in the removable side regions 124, 126 with the release tape in a manner similar to that discussed in relation to the first embodiment.

A third embodiment of a mailing device 210 in accordance with the invention is shown in FIG. 6. The mailing device 210 which is also in the form of mailer, sometimes referred to as a business or stationery form, comprises a blank 212 that is substantially identical to the blank 12 of the first embodiment described above in relation to the first embodiment. Accordingly detail of the blank will not be described further except where they differ from the blank of the first embodiment.

The removable edge regions 224, 226, 230 of the first panel to which a suitable adhesive has been applied are cover by a one piece U or horseshoe shaped tape 234 of a release liner material which is located to the outside of a one piece U or horseshoe shaped tear strip 250. The inner edge of the tear strip 250 is located adjacent the lines of weakness 220, 222, 228 that define the removable edge regions of the first panel. One end of the tear strip 250 forms a tab portion 252 which can be grasped by a user to open the mailer. An elongate aperture 254 is formed in second panel 216 at a position that overlies the tab portion 252 when the mailer is folded and sealed.

Both the release tape 234 and the tear strip are held in position by means of the adhesive 232 on the removable edge regions 224, 226, 230 of the first panel. Typically, the adhesive 232 is applied in strips along the removable edge regions having a width in the region of 7 mm. In this case the tear strip 250 may have a width in the range of about 1 mm to 3 mm, more preferable 1.5 mm to 2.5 mm, whilst the release tape has a width in the range 4 mm to 6 mm, more preferably 4.5 mm to 5.5 mm. However, it will be appreciated that the various widths of the adhesive strips, the release tape 234 and the tear strip 250 can be varied as required provided that sufficient adhesive is revealed when the release tape 234 is removed to allow the mailer to be effectively sealed and that the tear strip is able to function to open the mailer as described below.

To close the mailer 210, the release tape 234 is peeled away to reveal adhesive 232 on the removable edge regions of the first panel. The blank 212 is then folded so that the edge regions of the two panels are brought into contact and bonded by the adhesive 232. To open the mailer, the recipient or other user first releases the tab portion 252 of the tear strip 250 through the aperture 254. The tear strip 250 is also coated with a release agent on the side which contacts the adhesive and so is easily peeled away from the adhesive. Once the tab portion 252 has been lifted, it is grasped and pulled by the user so that the tear strip is pulled out bursting the second panel 216 along the lines of weakness. When the tear strip has been fully pulled and all the lines of weakness in the second panel burst, the central region of the second panel 216 within the lines of weakness can be folded out to reveal the contents of the mailer. The removable edge regions 224, 226, 230 of the second panel 216 remain bonded to the removable edge regions of the first panel.

In order to ensure that the tear strip 250 burst the lines of wetness in the second panel when pulled rather than breaking, it need to be made of a material that is sufficiently strong. Typically, the tear strip 250 is made from a material that has greater tear strength than the material of the blank 212. The tear strip could be made from so called tear proof or tear resistant paper such as Tyvek® manufactured by DuPont™ treated with a suitable release agent. Conveniently the release tape 234 and the tear strip 250 are produced from the same liner material which is kiss cut in the manner described above in relation to the first embodiment. In a suitable method, a planar piece or sheet of the liner material is positioned on the first panel 214 so as to cover the whole of the panel including the edge regions and is held in place by a light adhesion to the adhesive. The sheet is then kiss cut along the inner and outer edges of the tear strip 250. The central portion of the sheet inside the tear strip 250 can be removed and discarded or it can be used to form an inner sheet as described above in relation to the first embodiment. This may require the tear strip 250 to be displaced outwardly from the lines of weakness 222, 224, 228 so that the edges of the inner sheet can be adhered in the edge regions. Alternatively, the adhesive may extend inside the lines of weakness so that the tear strip can remain aligned with the lines of weakness. In this case, the peripheral edges of the inner sheet are bonded to the first panel inside the lines of weakness.

The tear strip arrangement provides an easy, one-step method of opening the mailer yet retains all the advantages of the conventional mailer arrangements. By forming the tear strip 250 together with the release tape 234 means there is little increase in manufacturing or material costs.

In the present embodiment, the first panel 214 is provided with removable edge regions defined by lines of weakness so that the mailer can still be opened by conventional methods. However, this is not essential and the lines of weakness in the first panel could be omitted. In this case, the adhesive would still be applied to the first panel 214 in edge regions that correspond to the removable edge regions of the second panel 216.

FIGS. 7 to 9 illustrate a fourth embodiment of a mailing device 310 in accordance with the invention.

The mailing device 310 comprises a blank 312 of foldable material. The blank is generally rectangular in shape and is divided into a first 314, a second 316, and a third 317 panel by means of first 318 and second 319 fold lines respectively. The panels are substantially identical in size and shape so that when the blank is folded about the fold lines, the panels overlay each other The first (314) and the third (317) panels are folded in substantially opposite directions (as indicated by the arrows in FIG. 9) in a substantially Z-shaped fold.

Longitudinal lines of weakness 320, 322 extend along either side of the blank to define removable edge regions 324a-c, 326a-c on the first 314, second 316, and third 317 panels.

A first transverse line of weakness 328 extends across the first panel 314 between the longitudinal lines of weakness 320, 322 spaced above the first fold line 318 to define a removable end edge region 330 of the first panel 314. A second transverse line of weakness 329 extends across the second panel 317 between the longitudinal lines of weakness 320, 322 to define a removable end edge region 331 of the second panel 316. The first and second transverse lines of weakness 328, 329 are equi-spaced about the first fold line 318.

A further transverse line of weakness 340 extends across the end of the third panel 317 remote from the fold line 319 between the longitudinal lines of weakness 320, 322 to define a removable end edge region 341 of the third panel.

In order to seal the mailing device when the blank 312 is folded, an adhesive 332 is applied to the inner surfaces of the removable edge regions 324a, 326a, 330, of the first panel 314. Any suitable adhesive can be used such as a pressure adhesive but in the present embodiment the adhesive is a contact adhesive of the type described in relation to the first embodiment. A generally U or horseshoe shaped tape (not shown) of releasable liner material will be provided to cover the adhesive in a manner known in the art and/or as described in relation to the first embodiment.

Adhesive can also be applied to a free end edge region 344 on the first panel 314. When the mailing device is folded, the adhesive on the free end edge region 344 bonds to the second panel 316. The mailing device is thereby sealed on all sides thereof, which reduces the risk of the mailing device being caught or jammed in automated sorting machinery. In this case, all four edges of the first panel may be covered with a tape of releasable liner material.

To close the mailer, the release liner is removed and the second panel 316 folded about the first fold line 318 over the first panel 314 so that the side edge regions of the two panels are bonded together. Apertures 343 are provided in the removable edge regions 324b, 326b, 329 of the second panel 316 leave the adhesive partially exposed. The third panel 317 is folded about the second fold line 319 in a direction substantially opposite that of second panel 316 about the first fold line 318, so that the removable edge portions 324c, 326c, 341 are brought into contact with the adhesive 332 on the first panel exposed through the apertures 343 and bonded thereto. When the mailer 310 is folded, the first 314 and third 317 panels overlap the second 316 panel on opposite sides thereof, so that the transverse lines of weakness 328, 329, 340 are in alignment with each other.

The apertures 343 may optionally be provided with security cuts 345. The security cuts are angularly spaced around the edges of the apertures 343 and extend radially therefrom. If a person attempts to open the mailing device by breaking the adhesive bond, the security cuts 345 increase the likelihood of tears forming in the second panel 316, thus indicating that the mailing device has been attempted opened.

To open the mailer, the recipient tears along the longitudinal lines of weakness to remove the side edge regions 324a-c, 326a-c. The recipient then tears along the top of the mailer along the transverse lines of weakness 328, 329, 340 to remove the removable end edge region 330 of the first panel 314, the removable end edge region 331 of the second flap 316, and the removable end edge region 341 of the third panel 317. Where adhesive is applied to the free edge region 344 of the first panel, the first panel will remain bonded to the second panel by the adhesive in this region when the mailer is opened.

The mailer 310 in accordance with the fourth embodiment can incorporate an inner sheet covering an inner region of the first panel in a manner similar to the first embodiment. The inner sheet and the release tape can be formed from a single piece of liner material which is positioned so as to cover the first panel 314 and held in position by the adhesive. The material is then kiss cut to define the tape and the inner sheet in the manner described above.

The mailer in accordance with the fourth embodiment reduces the amount of adhesive needed for sealing the mailer as it requires adhesive to be applied to only one panel. This reduces both the production cost and the production time. By comparison, prior art mailers of the Z fold type normally require adhesive to be applied to the removable edge regions of at least two of the panels.

The above embodiments are described by way of example only. Many variations are possible without departing from the scope of the invention.

1. A mailing device comprising a blank of foldable material defining at least two panels separated by one or more fold lines, at least two of the panels having removable edge regions defined by means of lines of weakness in the blank, an inner surface of the removable edge regions of a first of the panels having adhesive to enable the edge regions of said first panel to be bonded to corresponding removable edge regions of another panel when the blank is folded, wherein a sheet of material is affixed to an inner surface of one of the panels so as to cover at least an inner region of the panel within the lines of weakness.

2. A mailing device as claimed in claim 1, wherein the sheet is printed on.

3. A mailing device as claimed in claim 2, wherein the sheet is printed on with a security hatching or other security pattern.

4. A mailing device as claimed in any one of claims 1 to 3, wherein the sheet of material is affixed to the first panel, the adhesive on the removable edge regions of the first panel being covered by one or more release tapes made of the same material as the sheet.

5. A mailing device as claimed in claim 4, wherein the one or more tapes of liner and the sheet are formed from a single piece of die cut material.

6. A mailing device as claimed in claim 4 or claim 5, wherein the sheet extends beyond the lines of weakness defining at least two removable edge regions of the first panel so that peripheral portions of the sheet are affixed to the removable edge regions by means of the adhesive thereon.

7. A mailing device as claimed in any one of the preceding claims, in which the first panel has three removable edge regions, two of the removable edge regions being provided along opposite sides of the first panel and a third removable edge region extending along an end of the first panel interconnecting the sides, the adhesive on all three of the edge regions being covered by a single, continuous, generally U shaped tape of liner material.

8. A mailing device as claimed in any one of claims 1 to 7, wherein the blank defines two panels foldably connected by a first fold line, each of the panels having three removable edge regions, two of the removable edge regions being provided along opposite sides of each respective panel and a third removable edge region extending along an end of the respective panel opposite from the first fold line.

9. A mailing device as claimed in any one of claims 1 to 7, comprising a first and second panel connected by way of a first fold line, and a third panel connected to the second panel by way of a second fold line, the third panel being connected to an end of the second panel opposite the end connected to the first panel, wherein each of the panels comprise removable edge regions extending longitudinally along opposite sides of the first, second and third panels to form removable side edge regions, wherein first and second transverse lines of weakness extend respectively across the first panel and the second panel parallel to and equi-spaced from the first fold line to form removable end edge regions, and wherein the removable edge regions of said second panel are provided with a plurality of apertures, the arrangement being such that the first and third panels overlay the second panel on opposite sides thereof, the third panel being bonded to the first panel by way of said adhesive exposed through said apertures, when the blank is folded.

10. A mailing device as claimed in claim 9, wherein a transverse line of weakness extends substantially parallel to the free end of the third panel, said line of weakness extending between opposing side edges of the third panel or between said side edge regions of the third panel.

11. A method of manufacturing a mailing device as claimed in any one of claims 1 to 10, the method comprising: applying adhesive to the removable edge regions of the first panel portion, positioning a single planer piece of liner material over inner surface of the first panel covering substantially the whole of the first panel including at least those parts of the removable edge portions to which adhesive has been applied, and kiss cutting the piece of material to define the inner sheet and one or more removable tapes of liner material covering the adhesive on the removable edge regions of the first panel.

12. A method of manufacturing a mailing device as claimed in claim 11, wherein the method comprises kiss cutting the liner material at positions just outside the lines of weakness within the zones of adhesive applied to the removable edge regions so that peripheral edge portions of the sheet overlay part of the adhesive.

13. A mailing device comprising a blank of foldable material defining a first panel, a second panel foldably connected to a first end of the first panel by means of a first fold line, and a closure flap foldably connected to a second end of the first panel opposite the first end by means of a second fold line, wherein first and second transverse lines of weakness extend respectively across the first panel and the closure flap parallel to and equi-spaced from the second fold line, at least part of an outer end region of the cover flap on the opposite side of the second line of weakness from the second fold line having an adhesive on its inner surface, the arrangement being such that the outer end region of the cover flap overlays and can be bonded to an outer face of the second panel in when the blank is folded.

14. A mailing device as claimed in claim 13, wherein the second panel is dimensioned so that when folded about the first line, an end of the second panel opposite from the first fold line is positioned proximal to but on the opposite side of the first transverse line of weakness from the second fold line.

15. A mailing device as claimed in claim 13 or claim 14, wherein longitudinal lines of weakness extend along either side of the blank to define removable side edge regions of the first and second panels and the closure flap.

16. A mailing device as claimed in claim 15, wherein the first and second transverse lines of weakness extend across the first panel and the cover flap respectively between the longitudinal lines of weakness.

17. A mailing device as claimed in claim 15 or claim 16, wherein adhesive is applied to inner surfaces of the removable side edge regions of the first panel and the cover flap.

18. A mailing device as claimed in claim 17, wherein the adhesive on the removable side edge regions of the first panel and the cover flap and the outer edge region of the cover flap is covered by one or more releasable tapes of liner material.

19. A mailing device as claimed in any one of claims 15-18, wherein a sheet of material is affixed to the blank so as to substantially cover the inner surface of at least an inner region of the first panel within the longitudinal and first transverse lines of weakness.

20. A mailing device as claimed in claim 19 when dependent on claim 18, wherein the sheet of material covering the inner region of the first panel is made from the same material as the one or more releasable tapes of liner material covering the adhesive on the removable edge regions of the first panel and cover flap.

21. A mailing device as claimed in claim 20, wherein the one or more tapes of liner material and the sheet are formed from a single piece of die cut material.

22. A mailing device as claimed in any one of claims 19 to 21, wherein the sheet is printed on.

23. A mailing device as claimed in claim 22, wherein the sheet is printed on with a security hatching or other security pattern.

24. A mailing device comprising a blank of foldable material defining at least two panels separated by fold lines, at least one of the at least two panels having removable edge regions defined by means of lines of weakness in the blank, a first of the panels having edge regions that contact corresponding removable edge regions of a further one of the panels when the mailer is folded, an inner surface of the edge regions of one of the first and the further one of the panels having an adhesive for bonding the corresponding removable edge regions together when the blank is folded, a tear strip being affixed to the edge regions of the first panel, the tear strip having a tab portion at one end, the blank having an opening in the further panel which overlays the tab portion when the blank is folded to allow access to the tab portion.

25. A mailing device as claimed in claim 24, wherein the adhesive is applied to the edge regions of the first of the panels and a tape of releasable liner material covers the adhesive on the edge regions of the first panel outside the tear strip.

26. A mailing device as claimed in claim 25, wherein the tape of releasable liner material and the tear strip are made of the same material.

27. A mailing device as claimed in claim 25, wherein the tape of releasable liner material and the tear strip are formed from a single piece of die cut material.

28. A mailing device as claimed in any one of claims 24 to 27, wherein the tear strip is positioned so as to align with the line of weakness in the blank defining the at least one removable edge region of the other panel when the mailing device is folded.

29. A mailing device as claimed in claim 28, wherein which an inner edge of the tear strip is positioned to align with the line of weakness in the blank defining the at least one removable edge region of the other panel when the mailing device is folded.

30. A mailing device as claimed in claim 28, wherein the other panel has removable edge regions defined along both sides and along one end, the tear strip being substantially U or horseshoe shaped to align with the lines of weakness defining the three removable edge regions in the other panel when the blank is folded.

31. A mailing device as claimed in any one of claims 24 to 30, wherein the tear strip material has a greater tear resistance than the material of the blank.

32. A mailing device as claimed in claim 25, or any one of claims 26 to 31 when dependent on claim 25, wherein the tape of releasable liner material has a width in the range of 4 mm to 6 mm and the inner tear strip portion has a width of 1 mm to 3 mm.

33. A mailing device as claimed in claim 15, or any one of claims 26 to 32 when dependent on claim 25, wherein adhesive is applied in strips along the edge regions of the first panel, the outer portion of the tape of releasable liner material overlaying an outer portion of the strips and the tear strip portion overlying an inner portion of the strips.

34. A mailing device as claimed in claim 25, or any one of claims 26 to 33 when dependent on claim 25, wherein the first panel has edge regions defined along both sides and along one end opposite the first fold line, adhesive being applied to an inner surface of the three edge regions of the first panel, the tape of releasable liner material and the tear strip each comprising a single continuous length of releasable liner material having a generally U shape and extending about all three of the edge regions of the first panel.

35. A mailing device as claimed in any one of claims 24 to 34, wherein the edge regions of the first panel are removable edge regions defined by lines of weakness in the blank.

36. A method of manufacturing a mailing device as claimed in any one of claims 24 to 35, the method comprising: applying adhesive to the edge regions of the first panel portion, positioning a single planer piece of releasable liner material over inner surface of the first panel covering substantially the whole of the first panel including at least those parts of the edge portions to which adhesive has been applied, kiss cutting the liner material to define inner and outer edges of the tear strip.

37. A method as claimed in claim 36, the method further comprising removing the portion of liner material inside the tear strip.

38. A mailing device comprising a blank of foldable material defining a first and second panel connected by way of a first fold line, and defining a third panel connected to the second panel by way of a second fold line, the third panel being connected to an end of the second panel opposite the end connected to the first panel, the panels having removable side edge regions defined by means of lines of weakness formed longitudinally along either side of the blank, an inner surface of the removable edge regions of the first panel having adhesive to enable the edge regions of said first panel to be bonded to corresponding removable edge regions of the second panel when the blank is folded, wherein first and second transverse lines of weakness extend respectively across the first panel and the second panel parallel to and equi-spaced from the first fold line to form removable end edge regions, and wherein the removable edge portions of said second panel are provided with a plurality of apertures, the arrangement being such that the first and third panels overlay the second panel on opposite sides thereof, the third panel being bonded to the first panel by way of said adhesive exposed through said apertures, when the blank is folded.

39. A mailing device as claimed in claim 38, wherein a further transverse line of weakness extends substantially parallel to the free end of the third panel, said line of weakness extending between opposing side edges of the third panel or between said side edge regions of the third panel.

40. A mailing device as claimed in claim 39, wherein the adhesive on the removable side edge regions of the first panel is covered by one or more releasable tapes of liner material.
